(19) United States
(12) Patent Application Publication
(10) Pub. No.: US 2016/0290835 A1
(43) Pub. Date: Oct. 6, 2016

(54) FIBER OPTIC CABLE SYSTEM

(71) Applicant: SHELL OIL COMPANY, Houston, TX (US)

(72) Inventor: Brian Kelly MCCOY, Magnolia, TX (US)

(21) Appl. No.: 15/182,058

(22) Filed: Jun. 14, 2016

Related U.S. Application Data
(60) Provisional application No. 62/241,406, filed on Oct. 14, 2015.

(51) Int. Cl. G01D 5/353; F16L 58/02; F16L 57/00; G02B 6/44

(52) U.S. Cl. CPC G01D 5/353; G02B 6/4402; F16L 58/02; F16L 57/00

(57) ABSTRACT

A fiber optic cable system wherein one or more elongate metal strips extend parallel to each other in a longitudinal direction and at least one fiber optic cable is disposed adjacent to each of the one or more elongate metal strips. The at least one fiber optic cable also extends along the longitudinal direction. The one or more elongate metal strips and the at least one fiber optic cable are together encapsulated in an encapsulation, to form an encapsulated fiber optic cable extending in the same longitudinal direction.

### CROSS REFERENCE TO EARLIER APPLICATION

The present application claims benefit of U.S. Provisional application No. 62/241,406 filed 14 Oct. 2015.

### FIELD OF THE INVENTION

The present invention relates to a fiber optic cable system. Embodiments of the present invention are suitable for deployment in a borehole, for instance mounted on a tubular element.

### BACKGROUND OF THE INVENTION

In recent years the use of fiber optic (FO) sensors in downhole applications has increased. In particular, optical fibers that can serve as distributed temperature sensors (DTS), distributed chemical sensors (DCS), or distributed acoustic sensors (DAS). If provided with Bragg gratings or the like, such optical fibers can serve as discrete sensors capable of measuring various downhole parameters. In each case, light signals from a light source are transmitted through the FO sensor via one end of the FO sensor. Signals that have passed through the FO sensor are received at a receiver and analyzed in a microprocessor. The receiver may be at the same end of the FO sensor as the light source, in which case the received signals have been reflected within the FO sensor. Alternatively, the receiver may be at the opposite end of the FO sensor. In any case, the received signals contain information about the state of the cable along its length, which information can be processed to provide the afore-mentioned information about the environment in which the cable is located.

In cases where it is desired to obtain information about a borehole, The FO sensor must be positioned within the borehole. For example, it may be desirable to use DTS to assess the efficacy of individual perforations in the well. Typically the FO sensor is packaged within a cable (sometimes referred to as “fiber optic cable” or “FO cable”) to mechanically and chemically protect the FO sensor from the environment. Because the FO sensor needs to be deployed along the length of the region of interest, which may be thousands of meters of borehole, it is practical to attach the cable to the outside of tubing that is placed in the hole. In many instances, the cable is attached to the outside of the casing, so that it is in close proximity with the borehole. The cable may even be embedded in cement within the borehole.

A low profile magnetic orienting protector is described in US pre-grant publication No. 2015/0041117. The low profile magnetic orienting protector may comprise two solid metal strips clamped against a well tubular and essentially extending longitudinal and parallel to the well tubular. The metal strips may have a generally rectangular cross section and/or may have a concave inner surface that corresponds to the curvature of the outer surface of a clamp. The metal strips are spaced apart just enough to receive a FO cable between them, which FO cable extends parallel to both the metal strips and the well tubular. The metal strips may have a thickness, measured radially with respect to the well tubular, that is at least as large as the diameter of the FO cable to provide mechanical protection for the FO cable. The strips can be detected by an electromagnetic metal detector from inside of the well tubular to reveal the azimuthal location of the FO cable.

The metal strips may be provided on spools and may be unspooled and applied to the outside of a tubular along with fiber optic cable, as the tubular is run into a borehole. This way of deploying the fiber optic cable can be quite cumbersome at a well site.

### SUMMARY OF THE INVENTION

In accordance with a first aspect of the present invention, there is provided a fiber optic cable system comprising:
one or more elongate metal strips extending parallel to each other in a longitudinal direction;
at least one fiber optic cable disposed adjacent to the one or more elongate metal strips and extending along said longitudinal direction and parallel to each of the one or more elongate metal strips;
wherein the one or more elongate metal strips and the at least one fiber optic cable are together encapsulated in a thermoplastic material to form an integrated fiber optic cable system.

The invention will be further illustrated hereinafter by way of example only, and with reference to the non-limiting drawing.

### BRIEF DESCRIPTION OF THE DRAWING

FIG. 1 shows a perspective view of a tubular element on which a fiber optic cable system is mounted;

FIG. 2 shows a cross sectional view of a section of the tubular element of FIG. 1 and a fiber optic cable system according to a group of embodiments;

FIG. 3 shows a cross sectional view of a section of the tubular element of FIG. 1 and a fiber optic cable system according to another group of embodiments;

FIG. 4 shows a front view of a fiber optic cable system mounted on the tubular element; and

FIG. 5 shows a cross sectional view of a section of the tubular element of FIG. 1 and a fiber optic cable system that employs non-straight metal strips.

These figures are schematic and not to scale. Identical reference numbers used in different figures refer to similar components. Within the context of the present specification, cross sections are always assumed to be perpendicular to the longitudinal direction.

### DETAILED DESCRIPTION OF THE INVENTION

The person skilled in the art will readily understand that, while the detailed description of the invention will be illustrated making reference to one or more a specific combinations of features and measures, many of those features and measures are functionally independent from other features and measures such that they can be equally or similarly applied independently in other embodiments or combinations.

The present disclosure proposes a fiber optic cable system involving an encapsulated fiber optic cable. The encapsulated fiber optic cable comprises one or more elongate metal strips and at least one fiber optic cable, which are together encapsulated in an encapsulation.

This fiber optic cable system can be more easily deployed than the system as described in US pre-grant publication No. 2015/0041117. The mentioned constituents are integrated into a single integrated cable unit, which can be relatively easily affixed to a well tubular compared to two separate metal strips and a separate fiber optic cable. In preferred embodiments, the encapsulated fiber optic cable can be spooled around a single spool drum.

Furthermore, the fiber optic cable in this fiber optic cable system is better protected from the environment and against impacts from the outside. Particularly, when exposed to side loads or other forces, the metal strips may separate if not encapsulated. This would not only cause exposure of the FO cable to crushing and abrasion, it would also weaken the magnetic flux signals inside the tubular element making it harder to establish the azimuth of the FO cable. The encapsulation helps to overcome this weakness in the earlier proposal.

The material from which the encapsulation is made is suitably a thermoplastic material, and preferably an erosion-resistant thermoplastic material. Preferably, the thermoplastic material has a (relatively) high tensile modulus and yield, (relatively) high resistance against abrasion and erosion, (relatively) high melting temperature, and (relatively) high petro-chemical resistance. Suitable materials may include thermoplastic vulcanizates (TPV), of which Santoprene™ (ExxonMobil) is an example thermoplastic polyester elastomers (TPE), of which Hytrel™ TPC-ET (Dupont)is an example; thermoplastic polyurethanes (TPU) of which Lubrizol Estane™ is an example; and ECTFE, a copolymer of ethylene and chlorotrifluoroethylene of which Halar (Solvay) is an example. The latter may be employed as a coating around another encapsulation material. Ethylene propylene diene terpolymers (EPDM), which are extremely durable synthetic rubbers known to be used as roofing membranes, have also been considered.

A material that swells when exposed to steam and/or hydrocarbons may be advantageous as encapsulation material, particularly when the hydraulic tubing system is for instance embedded in a cement. Such hydraulic tubing system with encapsulation of a swellable material would have a degree of “self-sealing” property, where a cement bond around the cable is otherwise not optimal.

When seen in cross section, the encapsulation suitably comprises a circular concave inside contour section and a circular convex outside contour section. The one or more elongate metal strips and the at least one fiber optic cable may be positioned between the circular concave inside contour section and the circular convex outside contour section. Suitably, the circular concave inside contour section and the circular convex outside contour section are concentric to each other. The circular concave inside contour section further helps to stiffen the encapsulated fiber optic cable and to keep it against a tubular element during deployment. The circular concave inside contour section advantageously has a radius of curvature that conforms to the convex outward directed wall surface of the tubular element. This further improves both the mechanical protection when running the tubular element in a borehole as well as the detectability of magnetic flux signals inside the tubular element.

US pre-grant publication No. 2015/0041117 is incorporated herewith by reference in its entirety. Although it does not teach an encapsulated fiber optic cable as presently proposed, some of the concepts described therein can be applicable to the presently proposed fiber optic cable system as well.

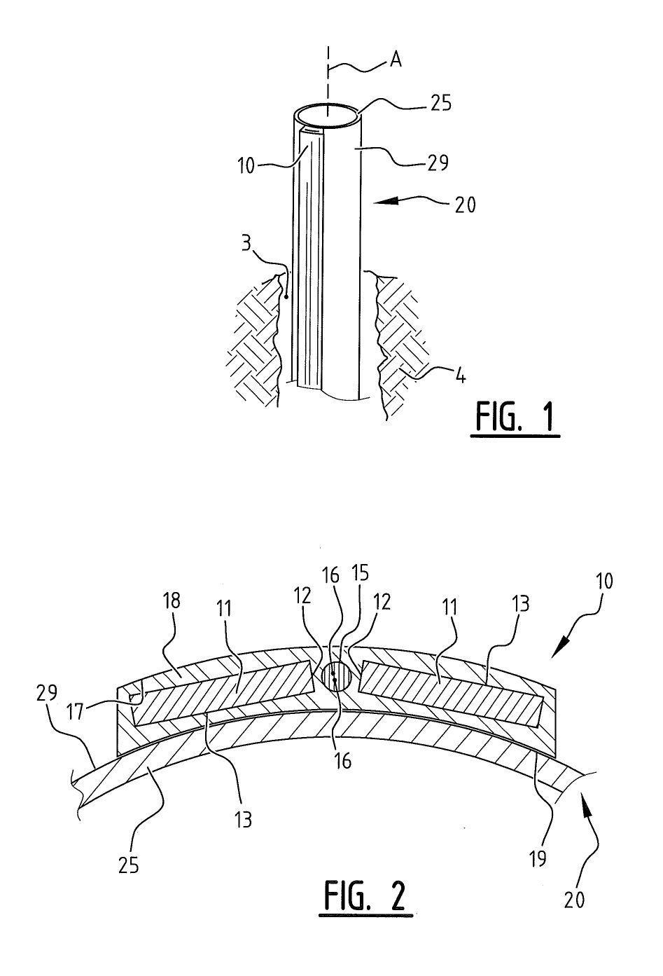

Referring now to FIG. 1, there is shown a perspective view of a fiber optic cable system 10 mounted on a tubular element 20. The tubular element comprises a cylindrical wall 25 extending about a central axis A, which is parallel to a longitudinal direction. The cylindrical wall 25, seen in cross section, has a circular circumference having a convex outward directed wall surface 29. The fiber optic cable system 10 is a fully encapsulated fiber optic cable that extends in the longitudinal direction.

The tubular element 20 may be deployed inside a borehole 3 drilled in an earth formation 5. The tubular element 20 may be (part of) any kind of well tubular, including for example but not limited to: casing, production tubing, lining, cladding, coiled tubing, or the like. The tubular element 20 may be any tubular or other structure that is intended to remain in the borehole 3 at during the duration of use of the fiber optic cable system 10 as FO sensor. The tubular element 20, together with the fiber optic cable system 10, may be cemented in place.

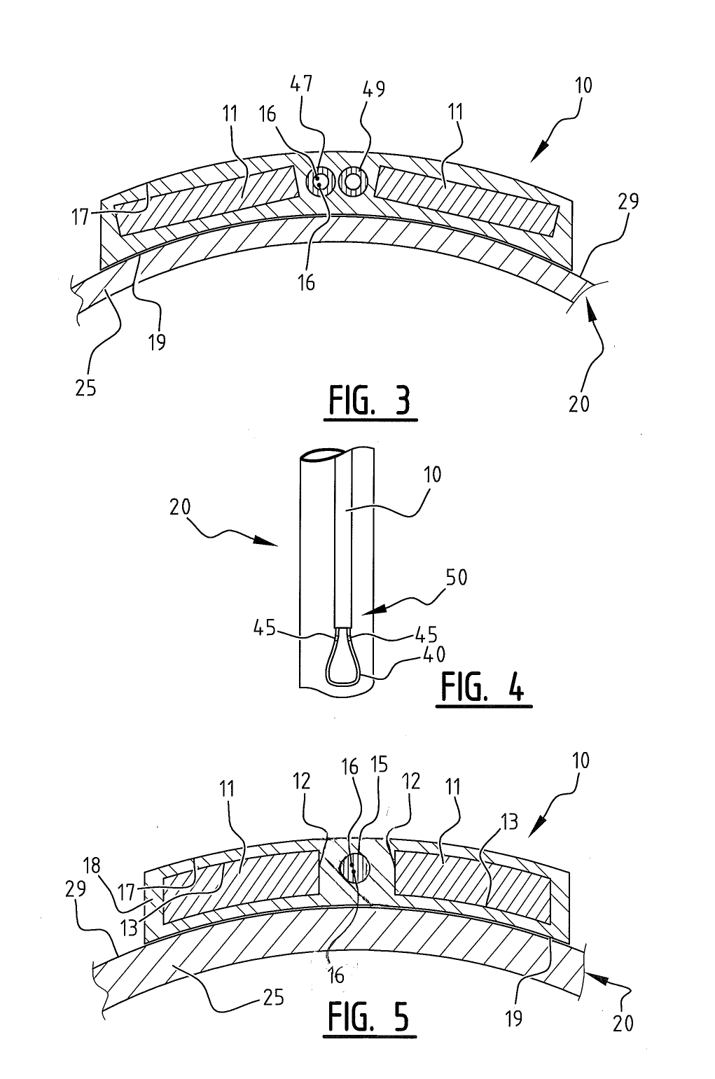

Two examples of the fiber optic cable system 10 are illustrated in FIGS. 2 and 3. These figures provide cross sectional views on a plane that is perpendicular to the longitudinal direction.

Starting with FIG. 2, the fiber optic cable system 10 comprises (at least) two elongate metal strips 11 and (at least) one fiber optic cable 15 disposed between the elongate metal strips 11. The fiber optic cable 15 and the elongate metal strips 11 all extend parallel to each other in the longitudinal direction (perpendicular to the plane of view). The elongate metal strips 11 and the fiber optic cable are together encapsulated in an encapsulation 18, thereby forming an encapsulated fiber optic cable extending in the longitudinal direction. In the embodiment of FIG. 2, the fiber optic cable 15 and the elongate metal strips 11 are fully surrounded by the encapsulation 18.

FIG. 3 shows an alternative group of embodiments, wherein the encapsulated fiber optic cable comprises a first length of hydraulic tubing 47 that is provided within the encapsulation. The first length of hydraulic tubing 47 extends along the longitudinal direction. The optical fiber(s) 16 may be disposed within the first length of hydraulic tubing 47.

According to a conceived method of producing the fiber optic cable system according to the alternative group of embodiments illustrated in FIG. 3, the encapsulation having at least the first length of hydraulic tubing 47 and the elongate metal strips 11 in it may first be produced and delivered as an intermediate product without any optical fibers. This intermediate product may subsequently be completed by inserting the optical fiber(s) 16 into the first length of hydraulic tubing 47. This may be done after mounting the intermediate product on the tubular element 20 and/or after inserting the intermediate product into the borehole 3 (with or without mounting on any tubular element).

One suitable way of inserting the optical fiber(s) 16 into the first length of hydraulic tubing 47 is by pumping one or more of the optical fiber(s) 16 through the first length of hydraulic tubing 47.

Suitably, the first length of hydraulic tubing 47 may be a hydraulic capillary line, suitably formed out of a hydraulic capillary tube. Such hydraulic capillary tubes are sufficiently pressure resistant to contain a hydraulic fluid. Such hydraulic capillary tubes are known to be used as hydraulic control lines for a variety of purposes when deployed on a well tubular in a borehole. They can, for instance, be used to transmit hydraulic power to open and/or close valves or sleeves or to operate specific down-hole devices. They may also be employed to monitor downhole pressures, in which case they may be referred to as capillary pressure sensor. Such hydraulic capillary tube is particularly suited in case the optical fiber(s) 16 are pumped through the hydraulic tubing.

Preferred embodiments comprise a second length of hydraulic tubing 49 within the encapsulation, in addition to the first length of hydraulic tubing 47. The material from which the second length of hydraulic tubing 49 is made, and/or the specifications for the second length of hydraulic tubing 49, may be identical to that of the first length of hydraulic tubing 47. The second length of hydraulic tubing 49 suitably extends parallel to the first length of hydraulic tubing 47.

Suitably, as schematically illustrated in FIG. 4, the fiber optic cable system 10 having first and second lengths of hydraulic tubing may further comprise a hydraulic tubing U-turn piece 40. The hydraulic tubing U-turn piece 40 is suitably configured at a distal end 50 of the encapsulated fiber optic cable 10, and it may function to create a pressure containing fluid connection between the first length of hydraulic tubing 47 and the second length of hydraulic tubing 49. When the fiber optic cable system 10 is inserted into a borehole, as schematically depicted in FIG. 1, the distal end 50 of the fiber optic cable system 10 suitably is the end that is inside the borehole 3 and furthest away from the surface of the earth in which the borehole 3 has been drilled. Suitably, connectors 45 are configured between the first length of hydraulic tubing 47 and the second length of hydraulic tubing 49 and respective ends of the hydraulic tubing U-turn piece 40. One way in which the hydraulic tubing U-turn piece 40 can be used is provide a continuous hydraulic circuit having a pressure fluid inlet and return line outlet at a single end of the fiber optic cable system 10. This single end may be referred to as proximal end. The preferred embodiments facilitate pumping optical fiber(s) 16 down hole from the surface of the earth, even if the well has already been completed and perforated.

More than two lengths of hydraulic tubing within a single encapsulation has also been contemplated.

The following part of the disclosure concerns subject matter that may apply to both the group of embodiments that is represented by FIG. 2, and the other group of embodiments that is represented by FIG. 3. Reference numbers have been employed in both figures.

The material from which the encapsulation 18 is made is suitably a thermoplastic material. Preferably the material is an erosion-resistant thermoplastic material.

Seen in said cross section, the encapsulation 18 preferably comprises a circular concave inside contour 19 section and a circular convex outside contour section 17, wherein the one or more elongate metal strips 11 and the at least one fiber optic cable 15 are positioned between the circular concave inside contour section 19 and the circular convex outside contour section 17. When mounted on the tubular element 20, the circular concave inside contour section 19 suitably has a radius of curvature that conforms to the convex outward directed wall surface 29 of the tubular element 20.

The fiber optic cable 15 typically comprises one or more optical fibers 16, which can be employed as sensing fibers. The optical fibers 16 may extend straight in the longitudinal direction, or be arranged in a non-straight configuration such as a helically wound configuration around a longitudinally extending core. Combinations of these configurations are contemplated, wherein one or more optical fibers 16 are configured straight and one or more optical fibers are configured non-straight.

The elongate metal strips 11 are each made out of a massive volume of metal, and both have a rectangular cross section. Other four-sided shapes have been contemplated as well, including parallelograms and trapeziums. Suitably the four-sided cross sections comprise two short sides 12 and two long sides 13, whereby the metal strips are configured within the encapsulation with one short side 12 of one of the metal strips facing toward one short side 12 of the other of the metal strips, whereby the fiber optic cable 15 is between these respective short sides.

The metal is suitably steel, but any electrically conductive or ferromagnetic material such as nickel, iron, cobalt, and alloys thereof, may provide satisfactory mechanical protection of the fiber optic cable and magnetic flux signals. The metal strips may for instance be extruded or roll formed. Suitably, for borehole applications the short sides measure less than 6.5 mm, preferably less than 4 mm, but more than 2 mm Thicknesses less than 2 mm provide insufficient magnetic flux signals inside the tubular element to detect, while thickness exceeding 6.5 mm is considered unfavourable to manage during the installation. The long sides are preferably more than 4× longer than the short sides. Suitably, the long sides are not more than 7× longer than the short sides, this in the interest of the encapsulation. The diameter of the FO cable may be between 2 mm and 6.5 mm, or preferably between 2 mm and 4 mm

Sides of the four-sided shape can be, but are not necessarily, straight. For instance, one or more of the sides may be curved. For instance, it is contemplated that one or both of the long sides are shaped according to circular contours. An example is illustrated in FIG. 5. The circular contours may be mutually concentric, and, if the fiber optic cable system is mounted on a tubular element, the circular contours may be concentric with the contour of the outward directed wall surface 29. If the encapsulation 18 comprises a circular concave inside contour 19 section and/or a circular convex outside contour section 17, circular contours of the elongate metal strips may be concentric with the circular concave inside contour 19 section and/or the circular convex outside contour section 17. Embodiments that employ metal strips 11 with non-straight sides may in all other aspects be identical to other embodiments described herein.

The fiber optic cable system comprising the encapsulated fiber optic cable is suitably spoolable around a spool drum. This facilitates deployment at a well site, for instance. The metal strips 11 can be taken advantage of when perforating the tubular element 20 on which the fiber optic cable system is mounted, as the azimuth of the fiber optic cable system may be established from inside of the tubular element by detecting magnetic flux signals inside the tubular element. This is amply described in, for instance, US pre-grant publication No. 2015/0041117. Perforating guns and magnetic orienting devices are commercially available in the market.

The person skilled in the art will understand that the present invention can be carried out in many various ways without departing from the scope of the appended claims. For instance, while FIGS. 2, 3, and 5 each show two elongate metal strips, it is possible to omit one of the two metal strips, or to employ additional metal strips.

What is claimed is:

1. A fiber optic cable system comprising:
one or more elongate metal strips extending in a longitudinal direction;
at least one fiber optic cable disposed adjacent to each of the one or more elongate metal strips and extending along said longitudinal direction and parallel to each of the one or more elongate metal strips;
wherein the one or more elongate metal strips and the at least one fiber optic cable are together encapsulated in an encapsulation, to form an encapsulated fiber optic cable extending in said longitudinal direction.

2. The fiber optic cable system of claim 1, wherein seen in a cross section perpendicular to the longitudinal direction the one or more elongate metal strips and the at least one fiber optic cable are fully surrounded by the encapsulation.

3. The fiber optic cable system of claim 2, wherein seen in said cross section the encapsulation comprises a circular concave inside contour section and a circular convex outside contour section wherein the one or more elongate metal strips and the at least one fiber optic cable are positioned between the circular concave inside contour section and the circular convex outside contour section.

4. The fiber optic cable system of claim 3, mounted on a tubular element, the tubular element comprising a cylindrical wall about a central axis that is parallel to the longitudinal direction, wherein the cylindrical wall seen in cross section has a circular circumference having a convex outward directed wall surface; wherein the circular concave inside contour section has a radius of curvature that conforms to the convex outward directed wall surface.

5. The fiber optic cable system of claim 1, wherein the one or more elongate metal strips are each made out of a massive volume of metal and each have a four-sided cross section.

6. The fiber optic cable system of claim 1, wherein the at least one fiber optic cable comprises a first length of hydraulic tubing that is provided within the encapsulation and extends in the longitudinal direction.

7. The fiber optic cable system of claim 6, further comprising a second length of hydraulic tubing within the encapsulation, extending parallel to the first length of hydraulic tubing.

8. The fiber optic cable system of claim 7, further comprising a hydraulic tubing U-turn piece, configured at a distal end of the encapsulated fiber optic cable to create a pressure containing fluid connection between the first length of hydraulic tubing and the second length of hydraulic tubing.

9. The fiber optic cable system of claim 6, wherein the first length of hydraulic tubing is a capillary line.

10. The fiber optic cable system of claim 1, wherein the encapsulation is made of a thermoplastic material.

11. The fiber optic cable system of claim 1, wherein said one or more elongate metal strips comprise at least two elongate metal strips extending parallel to each other.

12. The fiber optic cable system of claim 11, wherein the at least one fiber optic cable is disposed between at least two of the one or more elongate metal strips.

13. The fiber optic cable system of claim 1, wherein the encapsulated fiber optic cable is spoolable around a spool drum.
